(19) United States
(12) Patent Application Publication
(10) Pub. No.: US 2007/0140453 A1
(43) Pub. Date: Jun. 21, 2007

(54) Communication apparatus and information displaying method for communication apparatus

(75) Inventors: Masato Ohura, Fukuoka (JP); Mikio Shimazu, Fukuoka (JP); Makoto Matsuoka, Fukuoka (JP); Shinji Takizawa, Fukuoka (JP)

Correspondence Address: STEVENS, DAVIS, MILLER & MOSHER, LLP, 1615 L. STREET N.W., SUITE 850, WASHINGTON, DC, 20036, US

(73) Assignee: MATSUSHITA ELECTRIC INDUSTRIAL CO., LTD., Osaka (JP)

(21) Appl. No.: 11/633,065

(22) Filed: Dec. 4, 2006

(30) Foreign Application Priority Data
Dec. 5, 2005 (JP) P.2005-350372

(51) Int. Cl. H04M 15/06; H04M 1/56

(52) U.S. Cl. 379/142.06

(57) ABSTRACT

User information related to a predetermined user, including a user ID, is obtained from a server on a network. Telephone book information, including the user ID and a telephone number of a communication apparatus that the predetermined user uses, is input on an operation unit of the present communication apparatus. The user information and the telephone book information are stored while being associated based on the user ID. The telephone book information associated with the user information based on the user ID is displayed as secondary information of the user information, when the user information of the predetermined user is displayed on a display and when display of further information of the predetermined user is instructed.

### BACKGROUND OF THE INVENTION

1. Field of the Invention

The present invention relates to a communication apparatus and an information displaying method for a communication apparatus that perform communication based on user information stored in advance.

2. Description of Related Art

IP telephones have been widely used these days. An IP telephone service provider may have a new subscriber register user information of the subscriber on a server. The user information includes a user name, a user ID of the user, a date of birth of the user, an address of the user, a telephone number of the user other than the IP telephone number, and the like.

The user of such IP telephone service can obtain from the server, user information of another user stored on the server. The user can not only access an IP telephone of the another user, based on a user ID of the another user included in the obtained user information; but can also access a telephone terminal that the another user uses, based on a telephone number of the another user included in the user information (refer to Publication 1, for example).
[Publication 1] A thorough introduction to toll-free IP telephone with Skype. (2005, April). Media Tech Publishing, Inc., pp. 64-65.

However, the conventional technology has a problem described below.

Since the user information is controlled on the Internet server, any user of the system can obtain the user information. Thus, a user who registers information to the IP telephone may not include a telephone number and the like, in order to keep the personal information from a number of unspecified users. In this case, another user, who obtains the information from the server to communicate with the user, cannot know the telephone number other than the IP telephone, such as a landline telephone or a mobile telephone, even when the another user wants to access such telephone terminal.

### SUMMARY OF THE INVENTION

An object of the present invention is to provide a communication apparatus and a communication method that allow a user to have an easy access to various terminals that another user uses, while keeping personal information from a number of unspecified users.

To address the problem above, the communication apparatus according to the present invention, including an interface that obtains user information from a server on a network, the user information being related to a user and including a user ID of the user; an operation unit that inputs telephone book information, the telephone book information including the user ID and telephone number information of the user; a memory that stores the user information and the telephone book information, the user information being associated with the telephone book information; a display that displays the user information and telephone book information; and a controller that displays the telephone book information associated with the user information on the display, when the user information of the user is displayed and display of further information related to the user is instructed.

### BRIEF DESCRIPTION OF THE DRAWINGS

The present invention is further described in the detailed description which follows, with reference to the noted plurality of drawings by way of non-limiting examples of exemplary embodiments of the present invention, in which like reference numerals represent similar parts throughout the several views of the drawings, and wherein:

FIG. 1 illustrates a network configuration using a communication apparatus;

FIG. 2 is a block diagram of the communication apparatus;

FIG. 3 illustrates a memory structure of a contact list in the communication apparatus;

FIG. 4 illustrates a memory structure of a telephone book in the communication apparatus;

FIG. 5 illustrates a memory structure of a stored user list on a server;

FIG. 6 illustrates a memory structure of a stored contact list on the server;

FIG. 7 is a conceptual diagram of the server;

FIG. 8 is a display example of detailed user information of the contact list in the communication apparatus;

FIG. 9 is a display example of detailed user information of the telephone book in the communication apparatus;

FIG. 10 is a sequence diagram between the communication apparatus and the server;

FIG. 11A is a flowchart for storing a user in the telephone book of the communication apparatus;

FIG. 11B is a flowchart for linking a user ID between the contact list and the telephone book in the communication apparatus;

FIG. 12 is a sequence diagram between the communication apparatus and the server;

FIG. 13 is a flowchart for importing and associating the user information in the communication apparatus;

FIG. 14 is a flowchart illustrating an example of placing a call on the communication apparatus;

FIG. 15 is a display example of the contact list in the communication apparatus;

FIG. 16A is a display example of the detailed user information of the contact list in the communication apparatus;

FIG. 16B is a display example of the detailed user information of the contact list in the communication apparatus;

FIG. 16C is a display example of the detailed user information of the telephone book in the communication apparatus;

FIG. 16D is a display example of the detailed user information of the telephone book in the communication apparatus;

FIG. 17 is a flowchart of priority display of the contact list on the communication apparatus;

FIG. 18A illustrates a memory structure of contact list data in the communication apparatus;

FIG. 18B illustrates a memory structure of telephone book data in the communication apparatus;

FIG. 19A is a display example of the contact list without priority in the communication apparatus;

FIG. 19B is a display example of the contact list with priority in the communication apparatus;

FIG. 20A is a display example of the contact list without priority in the communication apparatus;

FIG. 20B is a display example of the contact list with priority in the communication apparatus.

FIG. 21 is an external view of a wireless communication terminal according to an embodiment of the present invention; and

FIG. 22 illustrates a configuration of the wireless communication terminal according to the embodiment of the present invention.

### DETAILED DESCRIPTION OF PREFERRED EMBODIMENTS

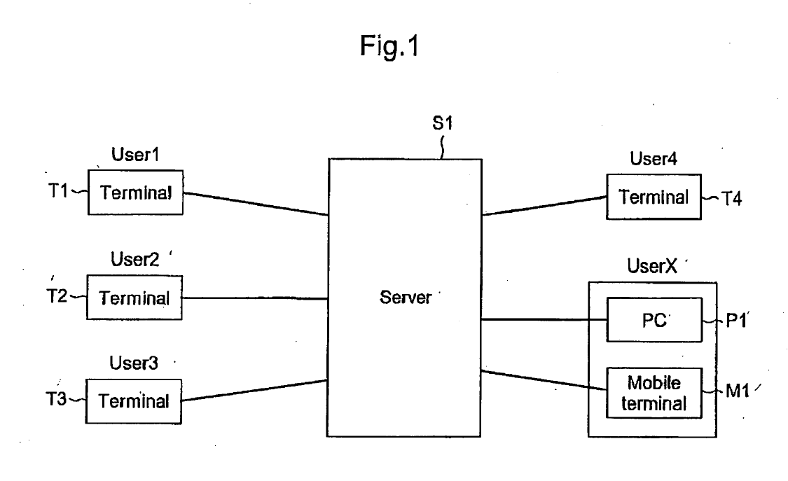

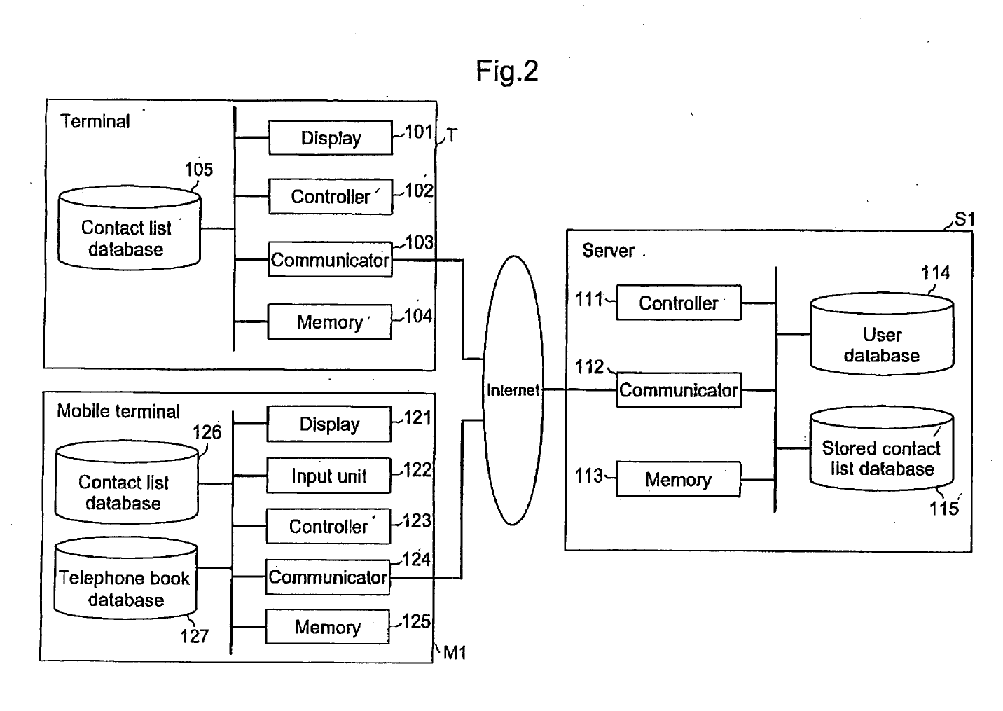

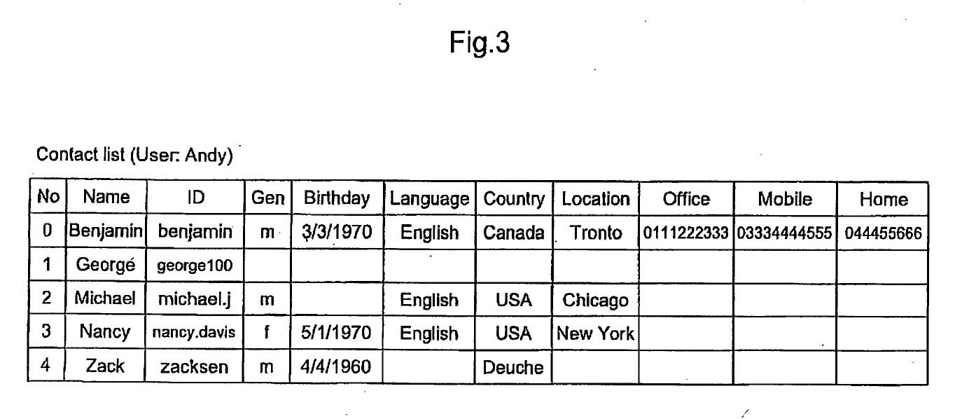

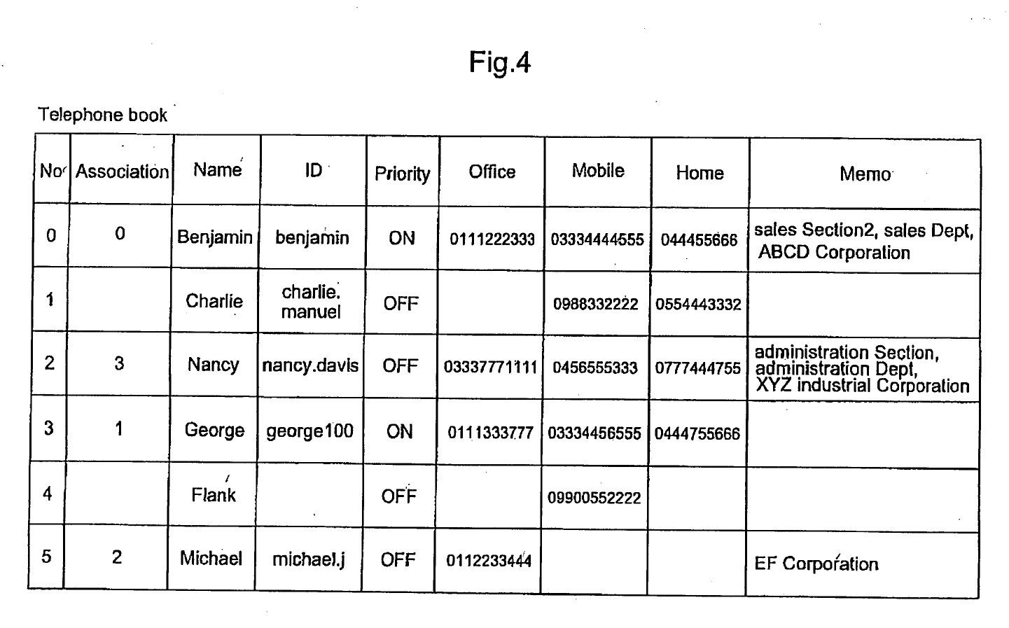

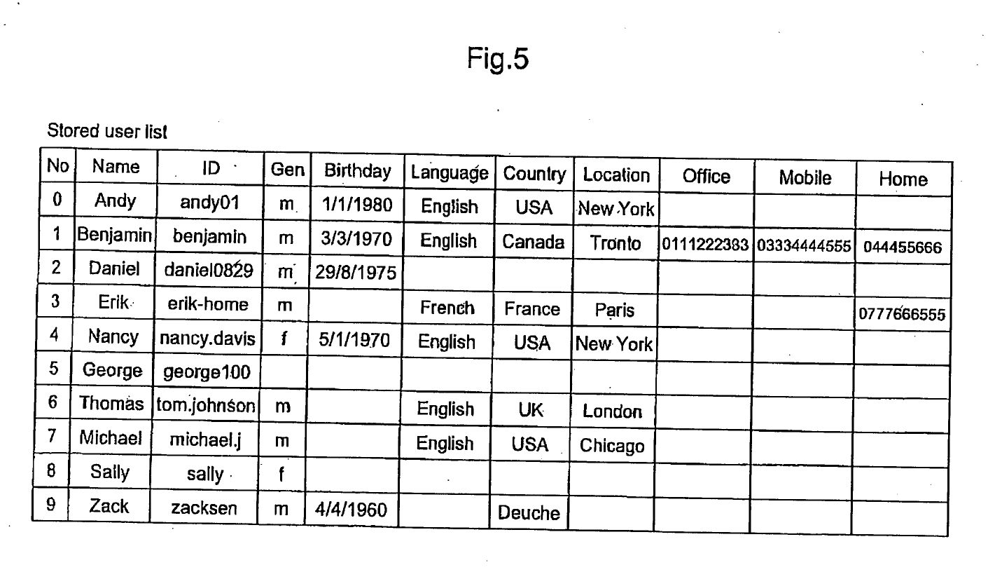

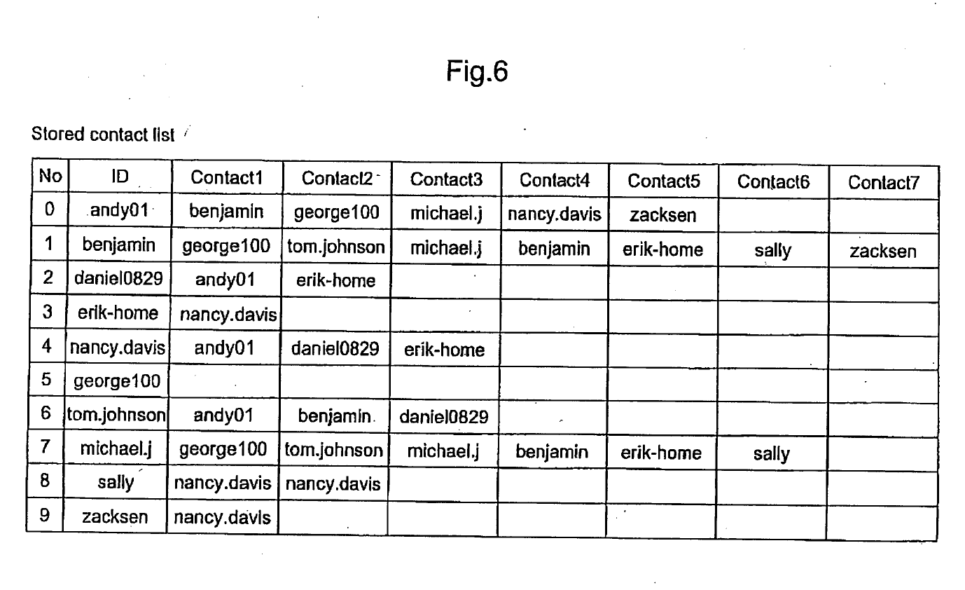

The embodiment of the present invention is explained in the following, with reference to the above-described drawings. FIG. 1 illustrates a network configuration using a communication apparatus. FIG. 2 is a block diagram of the communication apparatus. FIG. 3 illustrates a memory structure of a contact list in the communication apparatus. FIG. 4 illustrates a memory structure of a telephone book in the communication apparatus. FIG. 5 illustrates a memory structure of a stored user list on a server. FIG. 6 illustrates a memory structure of a stored contact list on the server.

A communication system shown in FIG. 1 includes four terminals T1 to T4, PC (personal computer) P1, mobile terminal M1, and server S1. Terminals T1 to T4 are used by users 1 to 4 respectively. PC P1 and mobile terminal M1 are used by user X.

Provided below are descriptions on mobile terminal M1 with reference to FIG. 2. Mobile terminal M1 has an IP telephone function and communicates via the Internet with another IP telephone terminal or a terminal other than the IP telephone terminal.

On mobile terminal M1, controller 123 controls components of the mobile terminal. Memory 125 stores a variety of information, a computer program, and the like used by controller 123. Communicator 124 controls communication complying with a predetermined communication protocol. Display 121 displays data and the like so that a user can view the data. Contact list database 126 stores a contact list shown in FIG. 3. Telephone book database 127 stores a telephone book shown in FIG. 4.

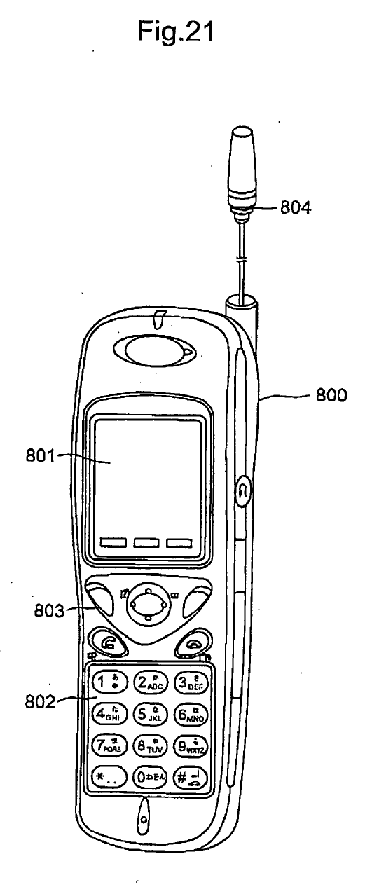

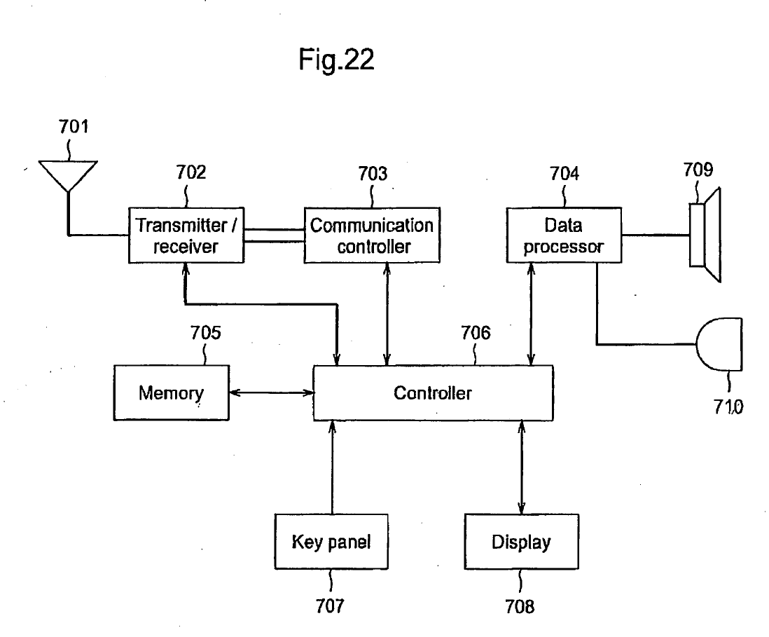

Described below is a wireless communication terminal, which can be used as an example of mobile terminal M1. FIG. 21 is an external view of wireless communication terminal 800 that can be used as mobile terminal M1 of the present embodiment. FIG. 22 illustrates a hardware configuration of wireless communication terminal 800.

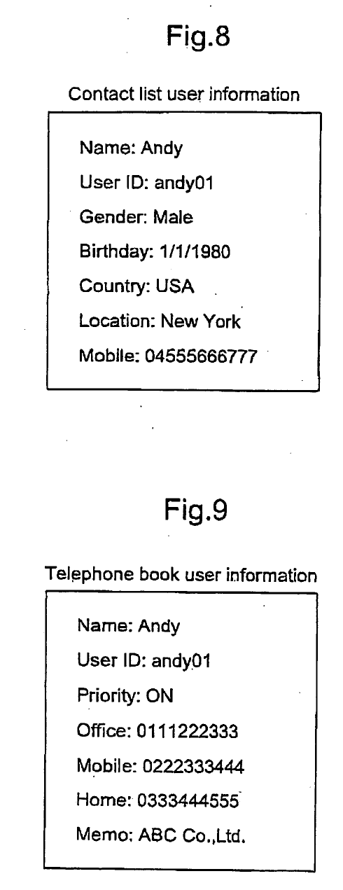

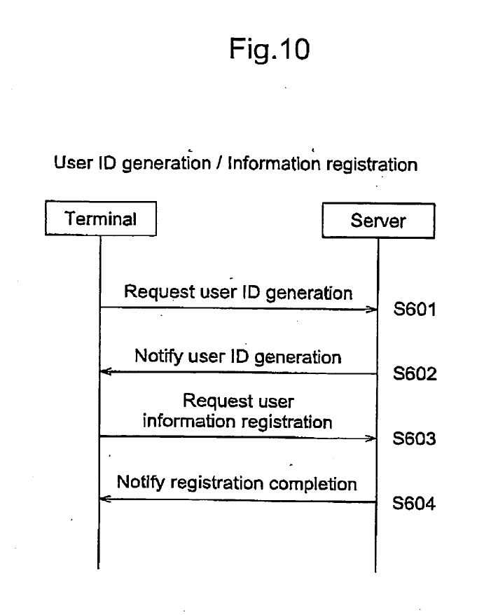

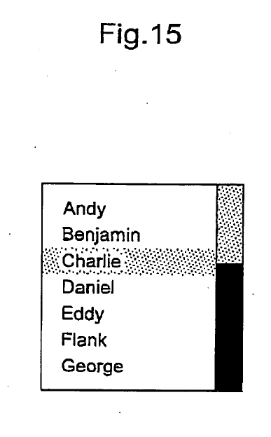

As shown in FIG. 21, wireless communication terminal 800 is provided with display 801, such as an LCD and the like; twelve (12) keys 802; function keys 803; antenna 804; and the like. Displayed on a screen of display 801 are a contact list as shown in FIG. 15, user information of the contact list as shown in FIG. 8, or user information of a telephone book as shown in FIG. 9. The screen further displays an input button via GUI that enables a service, such as IM, VoIP, e-mail, Web connection, presence information notice, and the like.

FIG. 22 shows antenna 701 for performing wireless communication with a wireless base station (not shown in the drawing); transmitter/receiver 702; communication controller 703; and data processor 704 that compresses and decompresses a signal for encoding and decoding. Transmitter/receiver 702 includes a frequency converter and a modulator/demodulator (not shown in the drawing). The receiver of the frequency converter combines a signal received at antenna 701 with a vibration signal of a predetermined frequency, in order to perfrom frequency conversion into an intermediate frequency signal (an IF signal). The transmitter of the frequency converter combines a modulation wave, which is supplied from the modulator/demodulator hereinafter described, with a vibration signal of a predetermined frequency in order to perform frequency conversion, and then transmits the converted signal from antenna 701. Further, the receiver of the modulator/demodulator demodulates the IF signal output from the frequency converter, and then transmits the demodulated signal to communication controller 703. The transmitter of the modulator/demodulator modulates data supplied from communication controller 703, and then transmits the modulated data to the frequency converter of transmitter/receiver 702.

Then, communication controller 703 performs frame synchronization and frame format. A receiver of communication controller 703 retrieves data for one frame at a predetermined timing from the data supplied from the modulator/demodulator of transmitter/receiver 702; descrambles the data; and transmits the upper-layer data to controller 706, which will be described hereinafter. Controller 706 then transmits the following data to data processor 704: multimedia data, such as a VoIP audio signal of an RTP payload, a video signal in MPEG, and the like; and IM text data. A transmitter of communication controller 703 adds a header to the data supplied from data processor 704; scrambles the IP-packetized data; and then transmits each frame to the modulator/demodulator of transmitter/receiver 702 at a predetermined timing.

Then, a receiver of data processor 704 decodes the multimedia data and the like supplied from controller 706 for decompression; performs D/A conversion into an analog audio and video signal and IM text data; and outputs the converted signal and data to speaker 709 and display 708 (hereinafter described). A display according to the present invention includes speaker 709 and display 708, which display audio, video, and text contents. A transmitter of data processor 704 performs A/D conversion into a data signal, of an analog audio signal input from microphone 710, a video signal from a camera and the like (not shown in the drawing), and a key input signal from key input section 707; decodes the data signal for compression; and transfers the compressed signal to controller 706 and transmits the signal to communication controller 703 as an IP packet.

Further shown are memory 705 that stores a contact list, telephone book information, a computer program, and the like; and key input section 707 used for setting a contact list, a telephone book, and the like, and for dialing and the like. The contact list or telephone book data input from key input section 707 are transferred to controller 706 and then stored in memory 705. When display of the contact list or telephone book is requested via key input, data input from key input section 707 are transferred to controller 706. Then, controller 706 obtains from memory 705 contact list or telephone book data required for display, generates data for display, and displays the data on a screen of display 708.

The contact list is user information that users 1 to 4, excluding user X, store on server S1 using terminals T1 to T4 and that is imported by user X to contact list database 126 of mobile terminal M1. As shown in FIG. 3, stored on the contact list are a serial number, a user name, a user ID, a gender of the user, a date of birth of the user, a language of the user, a country of the user, a city of residence of the user, a work telephone number of the user, a mobile telephone number of the user, a home telephone number of the user, and the like. The contact list stored in contact list database 126 is displayed on display 121 as a list.

The telephone book, which will be described hereinafter, is information that user X stores in telephone book database 127 of mobile terminal M1. The telephone book includes association, a user name, a user ID, priority, a work telephone number of the user, a mobile telephone number of the user, a home telephone number of the user, other information related to the user, and the like. The association herein means association with the contact list. The details thereof will be described hereinafter. The user ID links the contact list stored in contact list database 126 shown in FIG. 3 and the telephone book stored in telephone book database 127 shown in FIG. 4. The priority will be described hereinafter.

Described below is an overview of server S1 with reference to FIG. 2. Server S1 has a function that manages the user information of an IP telephone user, and communicates with another IP telephone terminal via the Internet.

On server S1, controller 111 controls components of the server. Memory 113 stores a variety of information, a computer program, and the like used by controller 111. Communicator 112 controls communication complying with a predetermined communication protocol. User database 114 stores the user information input on terminals T1 to T4, PC P1 and mobile terminal M1 by users 1 to 4 and X respectively. As shown in FIG. 5, user database 114 has all the user information in the communication system. Contact list database 115 manages the contact list of each user. As shown in FIG. 6, contact list database 115 contains the user ID that each user stores on the contact list.

User database 114 in FIG. 2 stores the user information of all the users of the communication system as a stored user list shown in FIG. 5. The user information includes a user name, a user ID, a gender of the user, a date of birth of the user, a language of the user, a country of the user, a city of residence of the user, a work telephone number of the user, a mobile telephone number of the user, a home telephone number of the user, and the like.

As shown in FIG. 6, stored contact list database 115 includes, for all the users, the user ID in the user information of another user, which is stored in contact list database 105 or 126 of each user's terminal. The user ID is associated with the user ID of the each user. For example, a user of mobile terminal M1 is Andy. Contact list database 126 of mobile terminal M1 stores the user information of Benjamin, George, Michael, Nancy, and Zack, as shown in FIG. 3. In this case, stored contact list database 115 in FIG. 6 has on line “No. 0” the user IDs of the users stored by Andy, that is, Benjamin, George, Michael, Nancy, and Zack. As described above, stored contact list database 115 includes the information of the users stored on each user's contact list for all the users of the communication system as a stored contact list.

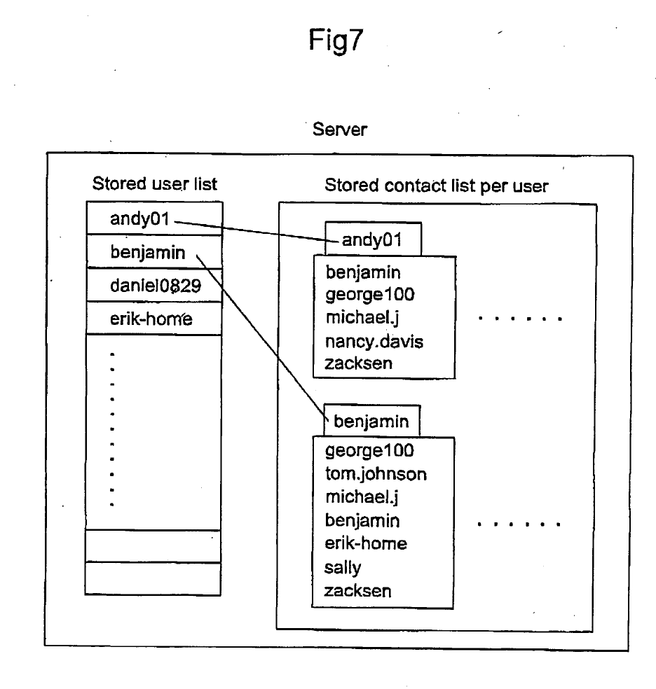

FIG. 7 is a conceptual diagram illustrating a relationship between the stored user list in user database 114 and the stored contact list in stored contact list database 115 of server S1. As shown in FIG. 7, the user ID links the stored user list and the stored contact list.

Described below is a case where the user information is displayed on display 121, with reference to FIGS. 8 and 9. The user information is stored in contact list database 126 or telephone book database 127 of mobile terminal M1. FIG. 8 is a display of the user information of one user stored on the contact list in contact list database 126. Displayed herein is Andy's detailed information, such as, for example, a user name, a user ID, a gender, a date of birth, a telephone number other than the IP telephone number, and the like. The information is stored in user database 114 of server S1 by the user whose information is displayed, and thus cannot be edited even when imported to mobile terminal M1. Further, the user ID is a unique number determined on the IP telephone shown in the communication system. The number can be used to access mobile terminal M1 from another IP telephone terminal. In addition to the number, the telephone number other than the IP telephone number is stored on the contact list in FIG. 8. The telephone number can be used to access Andy's terminal other than the IP telephone, such as, for example, a mobile telephone. Further, FIG. 9 is a display of Andy's information stored in telephone book database 127. Displayed are, for example, a user name, priority, a telephone number other than the IP telephone number, and the like.

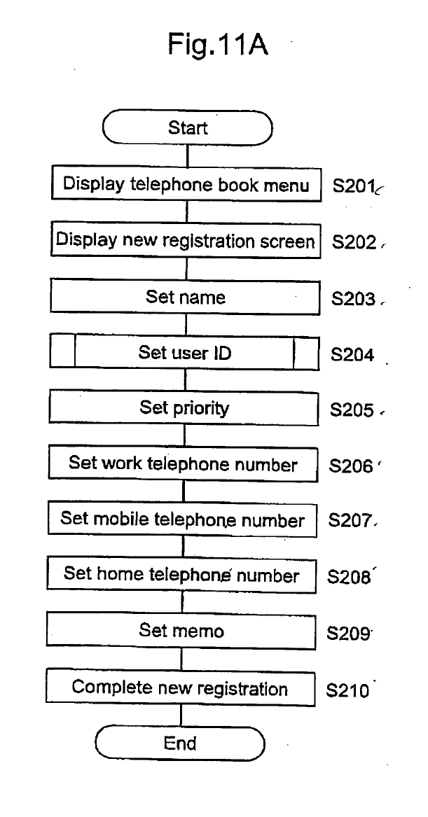

Described below is a process where the user stores the user information on server S1 using terminal T1, with reference to FIG. 10. FIG. 10 is a sequence diagram illustrating the storing process where the user stores the user information on server S1 using terminal T1.

User 1 first enters the user's user ID on terminal T1. Terminal T1 then transmits to server S1 a request for user ID generation (S601). Server S1 adds the user ID of user 1 in user database 114 and contact list database 115, and transmits to terminal 1 a notice of user ID generation (S602).

Communicator 103 of terminal T1 receives the notice of user ID generation. User 1 then enters the user information on terminal T1, and communicator 103 transmits to server S1 a request for user information registration (S603). Communicator 112 of server S1 receives the request, and controller 111 stores the received user information in an area of user 1 in user database 114. When completing storage, communicator 112 transmits a notice of registration completion (S604). Communicator 103 of terminal T1 receives the notice, thus completing storage.

Similar to the above-described process, user IDs of users 2 to 4 are generated and the user information is stored on server S1. As a result, user database 114 of server S1 stores the information of users 1 to 4 as shown in FIG. 5.

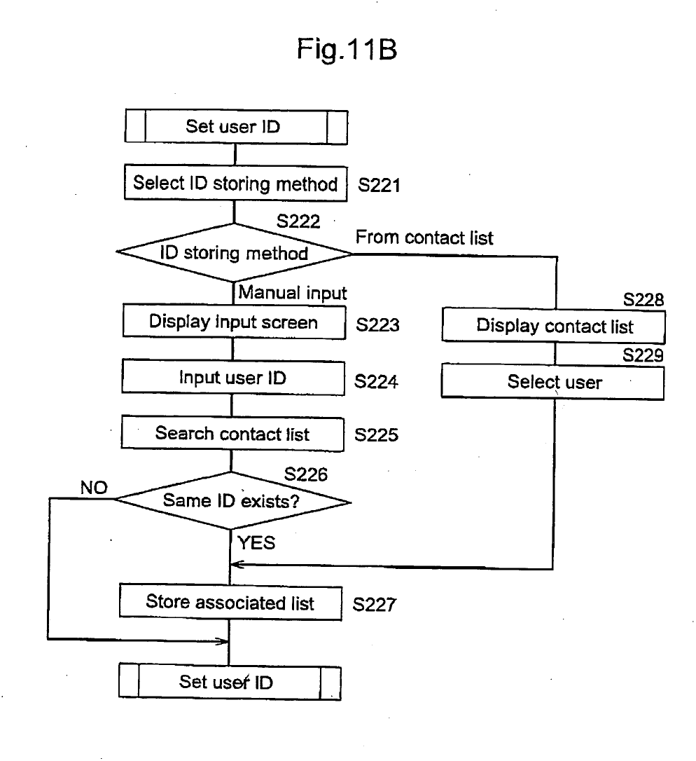

Described below is a process where user X stores the user information as the telephone book in telephone book database 127 of mobile terminal M1, with reference to FIG. 11A. FIG. 11A is a flowchart illustrating the storing process where the user stores the user information as the telephone book in telephone book database 127 of mobile terminal M1.

The contact list of user X herein has already stored the information of users 2 and 3. When user X starts storing the information of user 1 in the telephone book on mobile terminal M1, mobile terminal M1 displays a telephone book menu (S201) and then a new registration screen (S202). Then, user X enters the information of user 1 in each item on the new registration screen. More specifically, user X sets a name (S203), a user ID (S204), priority (S205), a work telephone number (S206), a mobile telephone number (S207), a home telephone number (S208), and a memo (S209). After setting the items, new registration is complete (S210).

Described below is telephone book user ID setting in step S204 with reference to FIG. 11B. FIG. 11B is a flowchart illustrating a process for setting the user ID when the user stores the user information as the telephone book in telephone book database 127 of mobile terminal M1.

User ID setting for user 1 is described first. The user first selects a storing method of the user ID of user 1 (S221). Since user 1 is not stored on the contact list, the user ID is input manually (S222). Selecting manual input displays a user ID input screen (S223). When the user ID of user 1 is input (S224), search of the contact list starts (S225). Since the user ID of user 1 is not on the contact list, user ID setting is complete (S226).

User ID setting for user 2 is described next. The user first selects the storing method of the user ID of user 2 (S221). Since user 2 is already stored on the contact list, the user ID is stored from the contact list (S222). Selecting an option of storing from the contact list displays the contact list (S228). The user ID of user 2 is then selected (S229). Then, a contact list number of user 2 is input in the association column of user 2 in the telephone book (S227), thus completing user ID setting. In case of the telephone book in FIG. 4, for example, the association column on line “No. 2” for Nancy is provided with “3,” indicating Nancy's information on line “No. 3” of the contact list in FIG. 3. The contact list in FIG. 3 and the telephone book in FIG. 4 are associated as described above.

Lastly, user ID setting for user 3 is described. The user first selects the storing method of the user ID of user 3 (S221). Although user 3 is already stored on the contact list, manual input of the user ID is selected (S222). Selecting manual input displays the user ID input screen (S223). When the user ID of user 3 is input (S224), search of the contact list starts (S225). Since the user ID of user 3 is on the contact list, a contact list number of user 3 is input to the association column of user 3 (S227), thus completing user ID setting. In case of the telephone book in FIG. 4, for example, the association column on line “No. 3” for George is provided with “1,” indicating George's information on line “No. 1” of the contact list in FIG. 3. The contact list in FIG. 3 and the telephone book in FIG. 4 are associated as described above.

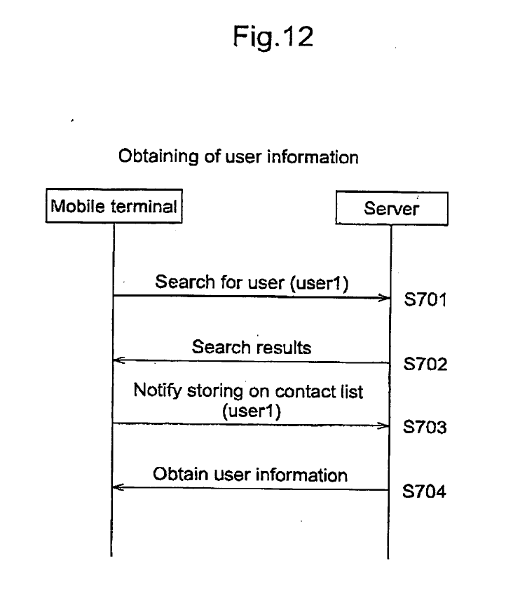

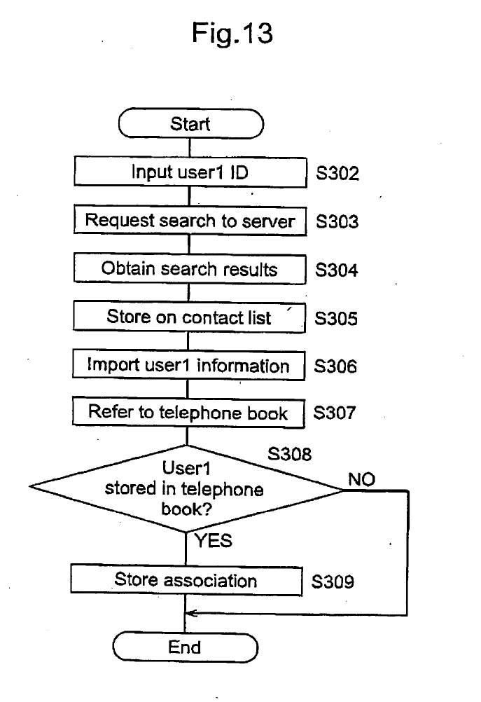

Described below is a process where user X obtains from server S1 the user information of user 1, with reference to FIGS. 12 and 13. FIG. 12 is a sequence diagram illustrating the process where the user obtains the user information from the server. FIG. 13 is a flowchart illustrating the process where mobile terminal X1 obtains the user information and associates the information with the contact list.

User X first enters the user ID of user 1 on mobile terminal M1 (S302) and starts searching. Mobile terminal M1 transmits to server S1 a search request of user 1 (S303 and S701). Communicator 112 of server S1 receives the search request. Controller 111 then refers to user database 114; retrieves user names that includes a string of the user name of user 1 as search results; and transmits all the search results to mobile terminal M1 (S702).

Mobile terminal M1 receives and displays the search results on display 121 (S304). User X selects user 1 from the search results and stores user 1 in contact list database 126 (S305). Communicator 124 transmits to server S1 a notice of contact list registration (S703). Server S1 receives the notice of contact list registration, and then controller 111 adds user 1 to an area of user X in stored contact list database 115 (FIG. 6). Further, server S1 retrieves the user information of user 1 from user database 114 (FIG. 5) and transmits the user information to mobile terminal M1 (S704). Mobile terminal M1 receives the user information of user 1, and then controller 123 inputs the user information in an area of user 1 in contact list database 126 (FIG. 3; S306), thus completing storing on the contact list.

Then, a process is performed for associating user 1 stored on the contact list with the telephone book. Controller 123 searches telephone book database 127 (FIG. 4), using the stored user ID of user 1 as a search key (S307). When the user ID of user 1 exists in the telephone book, a contact list number of user 1 is input in the association column of user 1 in the telephone book database (S309), thus completing storing of association. Thereby, referring to user 1 in the telephone book database provides the information of user 1 on the associated contact list. For example, when Nancy is added to the contact list in FIG. 3, the association column in the telephone book of FIG. 4 is provided with “3,” indicating “No. 3” on the contact list in FIG. 3. Thereby, Nancy's user information is linked between the contact list in FIG. 3 and the telephone book in FIG. 4.

In the above-described example of association, the association item is provided in the telephone book. However, the item may be included on the contact list. Further, a separate association list may exist, independent from the contact list or the telephone book.

Further in the above-described example of association, the associated contact list number is input in the association column in the telephone book when the user information is stored in the telephone book or the contact list. Instead of inputting the number in advance, however, the number may be associated as required by searching for the user in the telephone book from the contact list, or the user on the contact list from the telephone book.

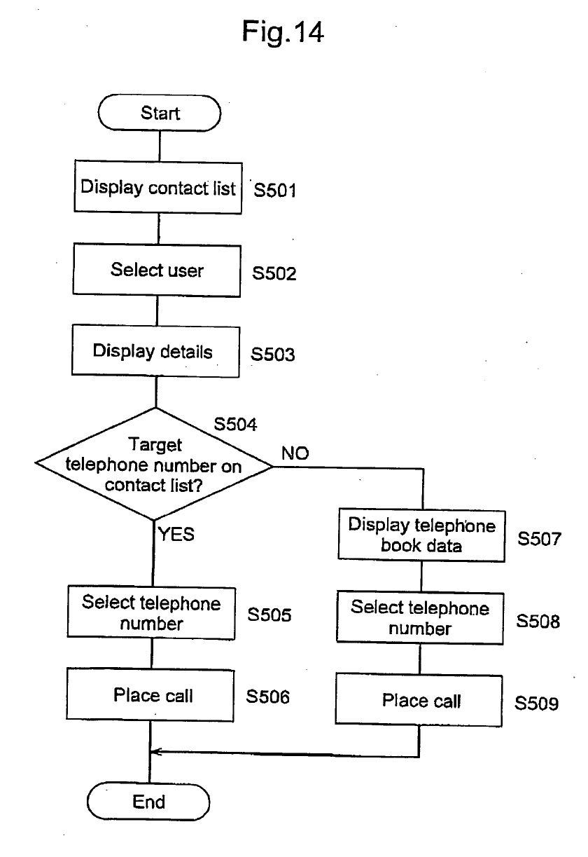

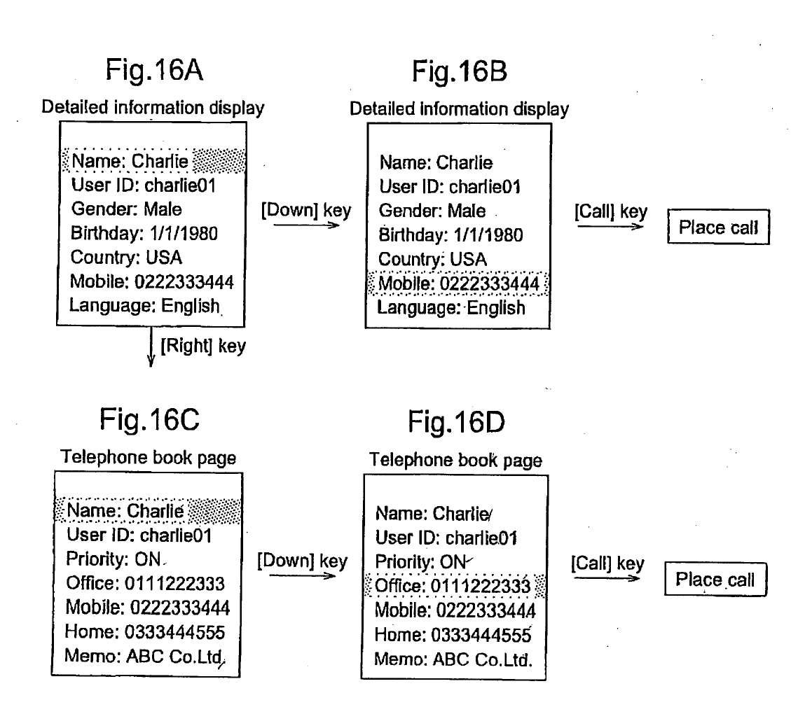

Described below are operations for placing a call to a telephone number other than the user ID of the IP telephone stored on the contact list or the telephone book, with reference to FIGS. 14, 15, and 16A to 16D. FIG. 14 is a flowchart illustrating the operations when user X refers to the user information on the contact list and the telephone book of mobile terminal M1, and places the call to the telephone number other than the user ID of the IP telephone. FIG. 15 is a display example when user X displays the contact list on mobile terminal M1. FIGS. 16A to 16D are display examples when user X refers to the user information on the contact list and the telephone book of mobile terminal M1, and places the call to the telephone number other than the user ID of the IP telephone.

First, a case is explained where user X places a call to Charlie's mobile telephone number, from a detailed user information screen of the contact list. User X first performs an operation for displaying the contact list, and then display 121 displays a list of users in the contact list database (S501). In FIG. 15, a shaded user “Charlie” is a currently selected user. To change the selected user, a key on mobile terminal M1 is used to scroll up or down the list and select a destination (S502). Explained herein is the case where Charlie is selected. When user X performs an operation for displaying the detailed information of the selected user Charlie, Charlie's detailed information is displayed (S503). FIG. 16A is a display example at the point.

In FIG. 16A, a shaded item is a currently selected item. The key on mobile terminal M1 is used to scroll up and down to change the selected item. Since Charlie's mobile telephone number appears on the detailed information screen in FIG. 16A (S504), the mobile telephone number is used to place the call. Since an item “Name” is selected in FIG. 16A, a “Down” key is used to change the selection to an item “Mobile” (S505), and a call key is used to place the call. Thereby, mobile terminal M1 places the call to Charlie's mobile telephone (S506). FIG. 16B shows a display example at the point.

Next, a case is explained where user X places a call to Charlie's work telephone number, from the detailed user information screen of the telephone book. Since Charlie's work telephone number does not appear on the detailed information screen of FIG. 16A (S504), a “Right” key is used to display Charlie's detailed information stored in the telephone book (S507). FIG. 16C is a display example at this point. Since the item “Name” is selected in FIG. 16C, the “Down” key is used to change the selection to an item “Office” (S508), and the call key is used to place the call. Thereby, mobile terminal M1 places the call to Charlie's work telephone (S509). FIG. 16D is a display example at the point.

As described above, even when no work telephone number of another user, Charlie, is included on the displayed contact list of the another user obtained from server S1, the telephone book information of the another user is displayed as secondary information, based on the user ID included in the user information of the another user. Thereby, the telephone number of the another user can be easily searched for, while the personal information is not released to a number of unspecified users.

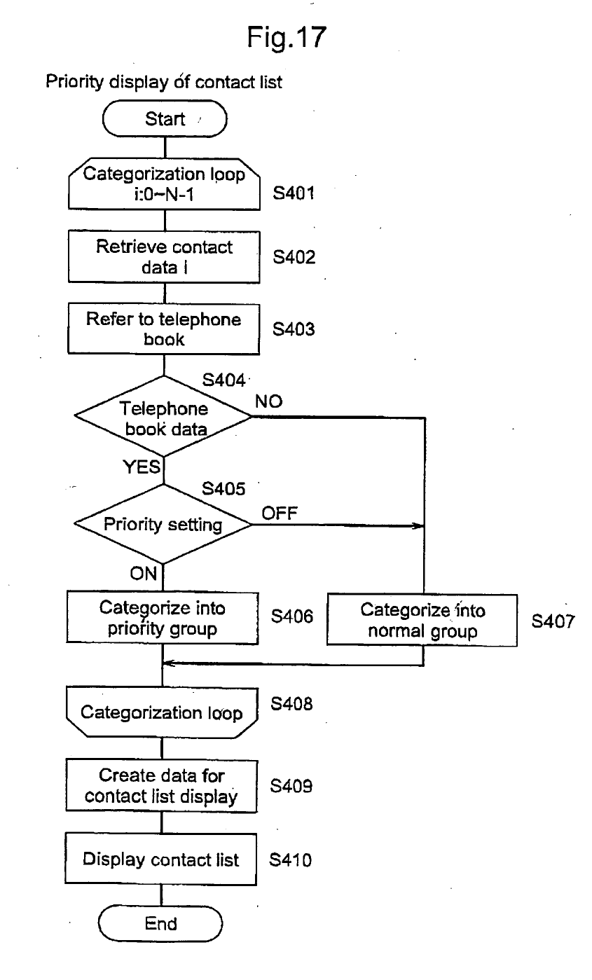

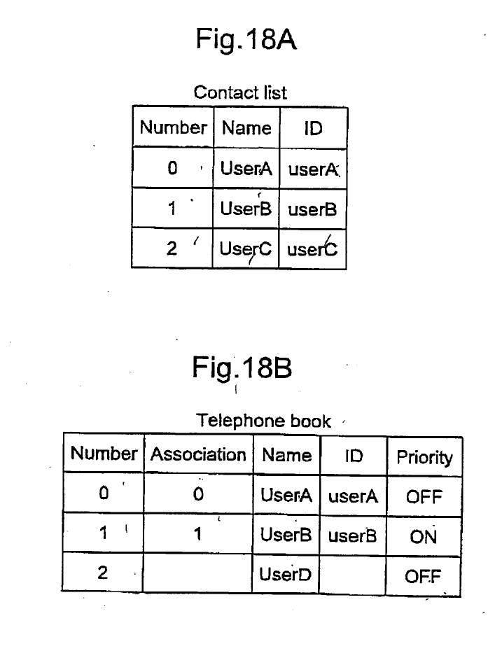

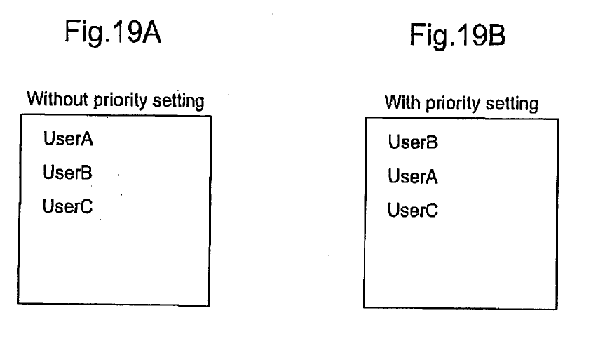

Described below are operations for priority display of a specified user on the contact list using the telephone book, with reference to FIGS. 17, 18A, 18B, 19A, and 19B. FIG. 17 is a flowchart illustrating a process for priority display of the contact list using the priority level item in the user information of the telephone book on mobile terminal M1. FIG. 18A illustrates a memory structure of the contact list at the point. FIG. 18B illustrates a memory structure of the telephone book at the point. FIGS. 19A and 19B are display examples of the contact list. FIG. 19A is the display example without priority display. FIG. 19B is the display example with priority display.

As shown in FIG. 18A, three users, user A, user B, and user C, are stored on the contact list. As shown in FIG. 18B, three users, user A, user B, and user D, are stored in the telephone book, but user C is not stored. Users A and B in the telephone book are associated with the contact lists. The association item in the telephone book indicates a contact list number of each user. Further, the priority level is set to user B, as the priority item indicates “On.”

User X performs operations for displaying the contact list. The user information of user A is first retrieved from contact list database 126 (S402), and telephone book database 127 is referred to (S403). User A, who is stored in the telephone book and whose priority is set to Off, is categorized into a normal group through processes in S404 and S405 (S407). Similarly, the user information of user B is retrieved (S402), and telephone book database 127 is referred to (S403). User B, who is stored in the telephone book and whose priority in the telephone book is set to On, is categorized into a priority group through the processes in S404 and S405 (S406). Similarly, the user information of user C is retrieved (S402), and telephone book database 127 is referred to (S403). User C, who is not stored in the telephone book, is categorized into the normal group (S407). The above-described operations are performed for all the users, and then the categorization is complete (S408).

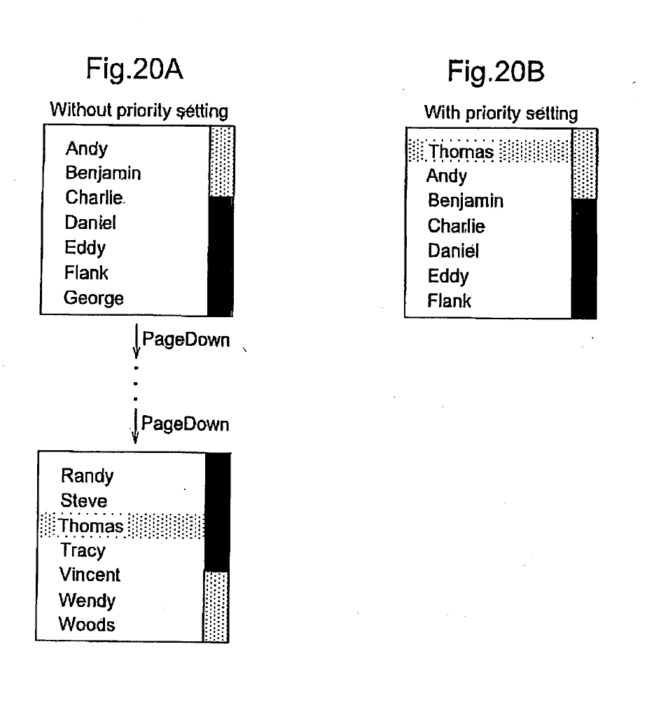

Next, data for contact list display are generated from the categorized groups (S409). The display data includes the data of the priority group followed by the data of the normal group. Display 121 displays the data (S410). FIG. 19B is the display example of the contact list at the point. When the priority of user B is set to Off, the display is as shown in FIG. 19A. Further, FIGS. 20A and 20B are the display examples of a case where a number of users are stored on the contact list. FIG. 20A is the display when no priority level is set, and FIG. 20B is the display when the priority level is set. As shown in FIG. 20B, when the priority of Thomas is set to On, Thomas is displayed at a top of the contact list.

In the descriptions above, there are two setting options, On and Off, for the priority. However, the priority setting may have three or more values.

As described above, the priority information can be included in the telephone book information, and the display order of the user information list is changed according to the priority information included in the telephone book information. Thus, even when a large number of users are stored, the user information of the frequently contacted users can be identified quickly.

The present embodiment describes the case where mobile terminal M1 has the telephone book therein. However, the telephone book may be included in a device connected to mobile terminal M1 via the Internet, such as server S1 and another terminal.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

The present invention is not limited to the above described embodiments, and various variations and modifications may be possible without departing from the scope of the present invention.

This application is based on the Japanese Patent Application No. 2005-350372 filed on Dec. 5, 2005, entire content of which is expressly incorporated by reference herein.

What is claimed is:

1. A communication apparatus comprising:
an interface that obtains user information from a server on a network, the user information being related to a user and including a user ID of the user;
an operation unit that inputs telephone book information, the telephone book information including the user ID and a telephone number information of the user;
a memory that stores the user information and the telephone book information, the user information being associated with the telephone book information;
a display that displays the user information and telephone book information; and
a controller that displays the telephone book information associated with the user information on said display, when the user information of the user is displayed and display of further information related to the user is instructed.

2. The communication apparatus according to claim 1, wherein said controller performs connection for communication with the user, based on the telephone number information.

3. The communication apparatus according to claim 1, wherein
said display has an area for displaying a list of the user information and the list is sorted in a predetermined order.

4. The communication apparatus according to claim 3, wherein the list is sorted based on a user name.

5. A communication apparatus comprising:
an interface that obtains user information from a server on a network, the user information being related to a user and including a user ID;
an operation unit that inputs telephone book information, the telephone book information including the user ID and a telephone number information of user, and that adds priority information of the user to the telephone book information;
a memory that stores the user information and the telephone book information, the user information being associated with the telephone book information;
a display that displays a list of the user information and the telephone book information; and
a controller that displays the list of the user information in a predetermined order based on the priority information and displays the telephone book information associated with the user information on said display, when the user information of the user is displayed and display of further information related to the user is instructed.

6. An information displaying method for a communication apparatus, having a memory to store user information and telephone book information, comprising:
obtaining the user information from a server on a network, the user information being related to the telephone book information;
storing the user information in the memory;
displaying the user information of the user; and
displaying the telephone book information associated with the user information, when the user information of the user is displayed and display of further information related to the user is instructed.
